(19) United States
(12) Patent Application Publication
(10) Pub. No.: US 2020/0313451 A1
(43) Pub. Date: Oct. 1, 2020

(54) MULTI-PURPOSE ELECTRICAL CHARGING STRUCTURE

(71) Applicant: Joon-Beom AN, Bucheon-si (KR)

(72) Inventors: Joon-Beom AN, Bucheon-si (KR); Sang-Mo KOO, Incheon (KR)

(73) Assignee: Joon-Beom AN, Bucheon-si (KR)

(21) Appl. No.: 16/425,399

(22) Filed: May 29, 2019

(30) Foreign Application Priority Data
Mar. 29, 2019 (KR) 10-2019-0037004

(51) Int. Cl. H02J 7/00; H02J 7/02; H01R 31/06; H01R 13/62; H01R 13/22

(52) U.S. Cl. CPC H02J 7/0045; H02J 7/025; H02J 7/0052; H02J 2007/0062; H01R 13/6205; H01R 13/22; H01R 31/06

(57) ABSTRACT

Provided is a multi-purpose electrical charging structure including a charging housing connected to an external power supply unit, an insertion type connector disposed in the charging housing and inserted into an insertion type port of an electronic device so that charging is capable of being performed, and a non-insertion type connector disposed in the charging housing and coupled to the non-insertion type port of the electronic device by magnetism so that charging is capable of being performed.

### CROSS-REFERENCE TO RELATED APPLICATIONS

This application claims the benefit of Korean Application No. 10-2019-0037004, filed Mar. 29, 2019, in the Korean Intellectual Property. All disclosures of the document named above are incorporated herein by reference.

### TECHNICAL FIELD

The present invention relates to a multi-purpose electrical charging structure, and more particularly, to a multi-purpose electrical charging structure in which an insertion type connector, a non-insertion type connector and a wireless charging pad are optionally disposed in a charging housing connected to an external power supply device so that charging of a variety of mobile phones can be performed using one charging housing.

### BACKGROUND ART

In general, portable electronic devices, such as mobile devices, smartphones, or tablet personal computers (PCs), are essentially used for communications in a modern society.

In such portable electronic devices, a connector of a peripheral device, such as a charging unit, is connected to a corresponding side surface of a portable electronic device so that an open type port capable of charging electronic devices is disposed. Also, a contact point terminal of an insertion type connector of the peripheral device is in a physical contact point with a contact point terminal of the open type port so that the use of the peripheral device, i.e., charging can be performed.

Recently, a connector of the peripheral device, such as the charging unit, is connected to electricity consumption products, such as electronic cigarettes or portable fans, in addition to the portable electronic devices, so that an open type port capable of charging the electricity consumption products is disposed.

However, the open type port of each of the portable electronic devices or electricity consumption products has a generally concave groove shape of “ [symbol] ”, and an insertion type connector of the peripheral device has a generally convex protrusion shape of “ [symbol] ”. Thus, damage in which physical contact point states of connectors may be loose according to mutual repetitive coupling and detachment so that contact states of the contact point terminals become bad or when the contact point terminals of the connectors are detached from each other, the contact point terminals of the connectors may be bent according to detachment directions, occurs.

Thus, in order to solve these problems, Korean Patent Registration Nos. 10-1639330 and 10-1370934 disclose a charging structure in which a gender having an insertion type connector and a non-insertion type port is detachably disposed at an open type port of a portable electronic device or electricity consumption product and a non-insertion type connector of a cable connected to a peripheral device is in a contact point with the non-insertion type port of the gender using magnetism.

However, in a charging structure using a magnetic interface according to the related art, when the non-insertion type connector of the cable is released from the contact point of the non-insertion type port of the gender, the gender is undesirably detached or removed from the open type port of an electronic device or electricity consumption product due to magnetism so that the gender has to be inserted and fixed into the open type port of the electronic device or electricity consumption product and thus, inconveniences of the use occur.

Also, when the gender is lost, the non-insertion type connector of the cable cannot be electrically connected to the open type port of the electronic device or electricity consumption product so that charging of the electronic device or electricity consumption product cannot be performed.

Thus, solutions in which the insertion type connector, the non-insertion type connector and the wireless charging pad are disposed at a single charging housing so that charging can be optionally performed using a connector or unit suitable for the electronic device or electricity consumption product or simultaneously, a plurality of electronic devices or electricity consumption products can be performed, are recently on the rise.

### DISCLOSURE OF THE INVENTION

The present invention provides a multi-purpose electrical charging structure in which an insertion type connector, a non-insertion type connector and a wireless charging pad are optionally disposed in a charging housing connected to an external power supply device so that charging of a variety of mobile phones can be performed using one charging housing.

According to an aspect of the present invention, there is provided a multi-purpose electrical charging structure including a charging housing connected to an external power supply unit, an insertion type connector disposed in the charging housing and inserted into an insertion type port of an electronic device so that charging is capable of being performed, and a non-insertion type connector disposed in the charging housing and coupled to the non-insertion type port of the electronic device by magnetism so that charging is capable of being performed.

According to another aspect of the present invention, there is provided a multi-purpose electrical charging structure including a charging housing connected to an external power supply unit, an insertion type connector disposed in the charging housing and inserted into the insertion type connector of an electronic device so that charging is capable of being performed, and a wireless charging pad, which disposed in the charging housing and on which part of the wireless charging pad of the electronic device is seated, so that charging is capable of being performed.

According to another aspect of the present invention, there is provided a multi-purpose electrical charging structure including a charging housing connected to a power supply unit, an insertion type connector disposed in the charging housing and inserted into the insertion type port of the electronic device so that charging is capable of being performed, a non-insertion type connector disposed in the charging housing and coupled to the non-insertion type port of the electronic device using magnetism so that charging is capable of being performed, and a wireless charging pad, which is disposed in the charging housing and on which part of the wireless charging port of the electronic device is seated, so that charging is capable of being performed.

### DESCRIPTION OF THE DRAWINGS

FIG. 1 is a perspective view of a multi-purpose electrical charging structure according to an exemplary embodiment of the present invention; and

FIGS. 2 through 5 respectively illustrate charging states of a charging housing in the multi-purpose electrical charging structure of FIG. 1.

### BEST MODE FOR CARRYING OUT THE INVENTION

Hereinafter, the present invention will be described more fully with reference to the accompanying drawings, in which exemplary embodiments of the invention are shown.

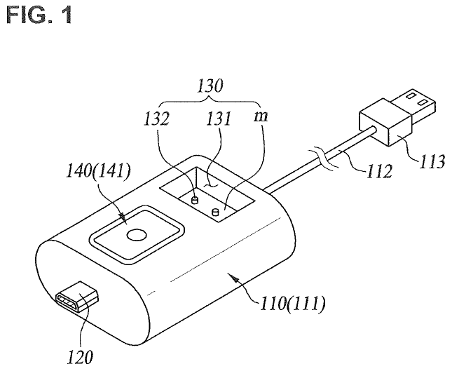

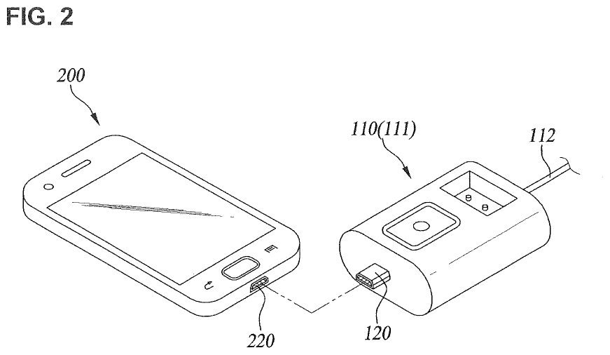

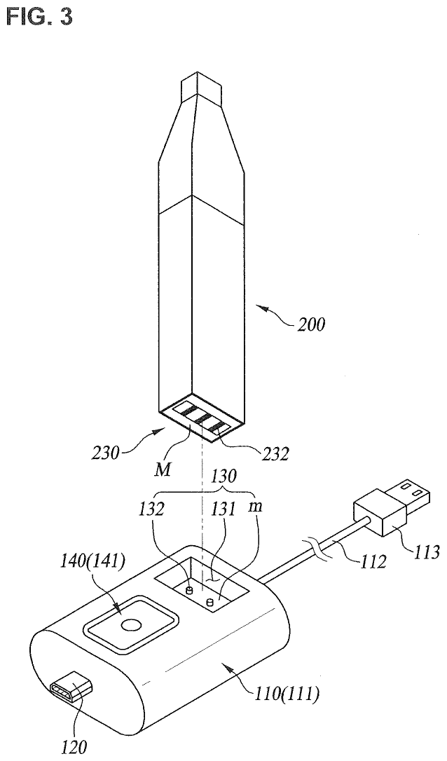

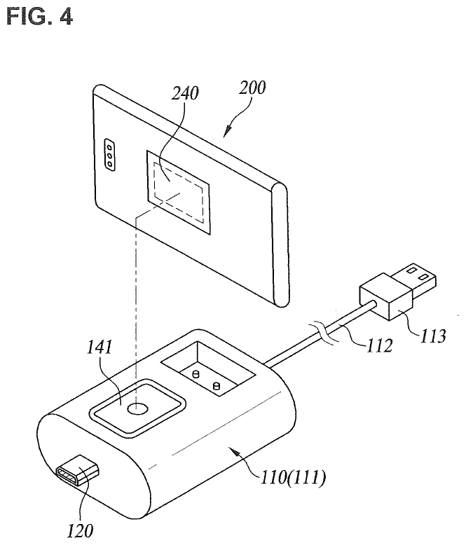

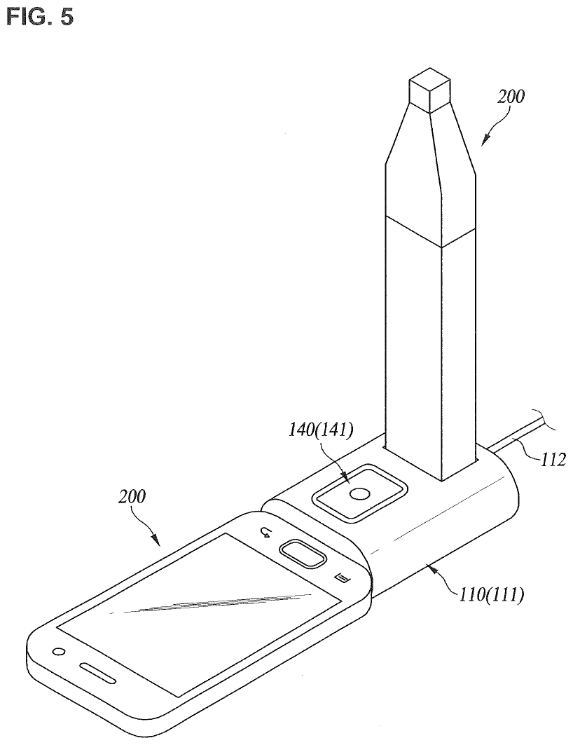

As illustrated in FIGS. 1 through 5, a multi-purpose electrical charging structure according to an embodiment includes a charging housing 110 connected to an external power supply unit, an insertion type connector 120 that protrudes from the charging housing 110 and is inserted into an insertion type port 220 of an electronic device 200, such as a smartphone or an electronic cigarette so that charging can be performed, a non-insertion type connector 130 that forms grooves in the charging housing 110, is coupled to the non-insertion type connector 130 of the electronic device 200, such as the smartphone or the electronic cigarette, by using magnetism so that charging can be performed, and a wireless charging pad 140, which is positioned in the charging housing 110 and on which part of a wireless charging port 240 of the electronic device 200, such as the smartphone or the electronic cigarette, is seated, so that charging can be performed.

The charging housing 110 is a unit through which the electronic device 200 including the insertion type port 220, the non-insertion type port 230, and the wireless charging port 240 can be charged by using one among the insertion type connector 120, the non-insertion type connector 130, and the wireless charging pad 140, respectively. The charging housing 110 includes a housing body 111 having a certain shape, a power supply port 113 that extends from the housing body 111 through a cable 112 or protrudes from the housing body 111 and is connected to an external power supply device, and an interface unit (not shown), which is positioned inside the housing body 111, is electrically connected between the power supply port 113, the insertion type connector 120, the non-insertion type connector 130, and the wireless charging pad 140, thereby allowing the supply of power for charging.

When the wireless charging pad 140 is provided, the housing body 111 may have a hexahedral or disk shape with a certain volume so that the electronic device 200 can be stably seated on the housing body 111, and when no wireless charging pad 140 is provided, the housing body 111 may have a hexahedral or disk shape with a relatively small volume.

The power supply port 113 may be a universal serial bus (USB) port that is conveniently attached/detached to/from an adaptor connected to the external power supply device and may be disposed on an end of the cable 112 that extends from the interface unit of the housing body 111 or may protrude directly toward the outside of the housing body 111 while being connected to the housing without the configuration of the cable 112.

The interface unit is a unit through which power supplied through the power supply port 113 is provided to the electronic device 200 so that charging can be performed. The interface unit may have a well-known configuration and thus a detailed description thereof will be omitted.

The insertion type connector 120 is a unit that protrudes toward the outside of the housing body 111 while being connected to the interface unit of the housing body 111 and allows power to be supplied by the interface unit when the insertion type connector 120 is inserted into the insertion type port 220 of the electronic device 200, so that charging can be performed. The insertion type connector 120 may have at least one configuration among well-known micro 5pin, USB C-type, and lightning 8pin.

The non-insertion type connector 130 is a unit that is disposed on one surface of the housing body 111 in a groove structure while being connected to the interface unit of the housing body 111 and allows power to be supplied by the interface unit when the non-insertion type connector 130 is coupled to the non-insertion type port 230 of the electronic device 200 using magnetism, so that charging can be performed. The non-insertion type connector 130 includes a seating groove 131, which is concavely formed in a top surface of the housing body 111 and into which and on which part of a housing having the non-insertion type port 230 of the electronic device 200 formed therein is inserted and seated, magnetism coupling members m, which are disposed on a bottom surface of the seating groove 131 and allow the magnetism coupling members m of the non-insertion type port 230 of the electronic device 200 to be coupled to one another by magnetism, and contact pins 132 through which, when the magnetism coupling members m are coupled to one another by magnetism, a contact terminal 232 of the non-insertion type port 230 of the electronic device 200 is in a contact point with the contact pins 132 in a non-insertion structure so that the contact pins 132 are coupled to one another to be mutually conductive.

Here, the non-insertion type port 230 of the electronic device 200 is disposed on one surface of the housing inserted into the seating groove 131. More preferably, the magnetism coupling members m are disposed on one surface of the housing inserted into the seating groove 131 so that the contact terminal 232 is in a contact point with the contact pins 132 in a state in which coupling using mutual magnetism is stably maintained.

In this case, at least one of the non-insertion type connector 130 and the magnetism coupling members m of the non-insertion type port 230 may be a magnet, and the contact terminal 232 of the non-insertion type port 230 has a flat surface terminal structure, and the contact pints 132 of the non-insertion type connector 130 have an elastic terminal structure, such as pogo pin.

Meanwhile, in the present invention, preferably, when the non-insertion type connector 130 is exposed to the charging housing 110, a short prevention unit (not shown) is further disposed between the non-insertion type connector 130 and the interface unit. The short prevention unit includes a voltage short prevention circuit that cuts off a current when the contact pins 132 of the non-insertion type connector 130 are shorted due to an external conductive material and thus short occurs in a power supply line of VCC and GND.

Thus, according to the short prevention unit, while the electronic device 200 is charged using the insertion type connector 120 excluding the non-insertion type connector 130 or the wireless charging pad 140, when the contact pins 132 of the non-insertion type connector 130 being not used are in contact with the external conductive material, a current may be prevented from flowing between the interface unit and the non-insertion type connector 130.

Meanwhile, in the present invention, preferably, an ID determination unit (not shown) may be further disposed between the non-insertion type connector 130 and the interface unit. The ID determination unit includes a magnetism-sensing sensor (not shown) for sensing magnetism generated when connecting is performed through magnetism coupling of the magnetism coupling members m disposed in the non-insertion type connector 130 and the non-insertion type port 230 of the electronic device 200, and a magnetism analysis unit (not shown), which is connected to the magnetism-sensing sensor in a conductive state and is switched so that power is supplied between the contact terminal 232 and the contact pins 132 when the sensed magnetism corresponds to a predetermined value.

Thus, according to the ID determination unit, when the non-insertion type port 230 is coupled to the non-insertion type connector 130 by magnetism, and only when the magnetism corresponding to the predetermined value is sensed by the magnetism-sensing sensor, switching is performed so that power supply between the contact terminal 232 and the contact pins 132 is performed. Thus, short and short-circuit of the contact pins 132 exposed to the outside may be prevented, and a mutual ID function can be provided so that problems caused by rated voltage errors generated when not genuine articles but articles not for sale are used, can be prevented from occurring.

The wireless charging pad 140 is a unit, which is exposed to one surface of the housing body 111 while being connected to the interface unit of the housing body 111, and which, when a wireless charging port 240 of the electronic device 200 is seated on the wireless charging pad 140, allows power to be supplied by the interface unit so that wireless charging can be performed. The wireless charging pad 140 includes a seating pad 141, which is disposed on a top surface of the housing body 111 and on which part of the housing having the wireless charging port 240 of the electronic device 200 is in surface contact with the seating pad 141, a transmission coil (not shown), which is disposed inside the seating pad 141 and forms a surface around which a coil relating to wireless charging is wound, and a transmission coil substrate (not shown) in which the transmission coil is disposed and which is connected to the interface unit so as to convert operating power into an induced electromotive force.

Here, the wireless charging pad 140 may have a well-known configuration and thus, a detailed description thereof will be omitted.

Also, the wireless charging port 240 of the electronic device 200 includes a reception coil (not shown), which forms a surface around which the coil relating to wireless charging is wound, and a wireless charging module (not shown), which collects power induced to the reception coil.

Hereinafter, the operation of the multi-purpose electrical charging structure according to the present invention will be described.

First, charging of the electronic device 200 using the insertion type connector 120 of the charging housing 110 is performed when the insertion type connector 120 of the charging housing 110 is inserted into the insertion type connector 220 of the electronic device 200 and then the power supply port 113 of the charging housing 110 is connected to the external power supply device via the adaptor.

Meanwhile, charging of the electronic device 200 using the non-insertion type connector 130 of the charging housing 110 is performed when part of the housing having the non-insertion type port 230 of the electronic device 200 formed therein is stably inserted into the seating groove 131 of the charging housing 110 and in this case, due to coupling caused by magnetism of the magnetism coupling member m, the contact terminal 232 of the electronic device 200 and the contact pins 132 of the charging housing 110 are in a non-insertion contact point state and then, the power supply port 113 of the charging housing 110 is connected to the external power supply device via the adaptor.

Meanwhile, charging of the electronic device 200 using the wireless charging pad 140 of the charging housing 110 is performed when the housing having the wireless charging port 240 of the electronic device 200 is stably seated on the seating pad 141 of the charging housing 110 and then, when the power supply port 113 of the charging housing 110 is connected to the external power supply device via the adaptor, power induced to the wireless charging port 240 of the electronic device 200 is transferred from the seating pad 141 of the charging housing 110.

Here, each of the insertion type connector 120, the non-insertion type connector 130, and the wireless charging pad 140 of the charging housing 110 may be charged and controlled, or they may be simultaneously charged and controlled.

Thus, according to the present invention, the insertion type connector 120, the non-insertion type connector 130, and the wireless charging pad 140 are optionally disposed in the charging housing 110 connected to the external power supply device so that charging of various mobile phones can be performed using one charging housing 110.

According to the present invention, an insertion type connector, a non-insertion type connector, and a wireless charging pad are optionally disposed in a charging housing connected to an external power supply device so that charging can be optionally performed using a connector or unit suitable for an electronic device or an electricity consumption product through one charging housing, or simultaneously a plurality of electronic devices or electricity consumption products can be charged.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multi-purpose electrical charging structure comprising:
a charging housing connected to an external power supply unit;
an insertion type connector disposed in the charging housing and inserted into an insertion type port of an electronic device so that charging is capable of being performed; and
a non-insertion type connector disposed in the charging housing and coupled to the non-insertion type port of the electronic device by magnetism so that charging is capable of being performed.

2. A multi-purpose electrical charging structure comprising:
a charging housing connected to an external power supply unit;
an insertion type connector disposed in the charging housing and inserted into the insertion type connector of an electronic device so that charging is capable of being performed; and
a wireless charging pad, which disposed in the charging housing and on which part of the wireless charging pad of the electronic device is seated, so that charging is capable of being performed.

3. A multi-purpose electrical charging structure comprising:
a charging housing connected to a power supply unit;
an insertion type connector disposed in the charging housing and inserted into the insertion type port of the electronic device so that charging is capable of being performed;
a non-insertion type connector disposed in the charging housing and coupled to the non-insertion type port of the electronic device using magnetism so that charging is capable of being performed; and
a wireless charging pad, which is disposed in the charging housing and on which part of the wireless charging port of the electronic device is seated, so that charging is capable of being performed.

4. The multi-purpose electrical charging structure of claim 1, wherein the charging housing comprises:
a housing body; and
a power supply port extending from the housing body via a cable or protruding from the housing body and being connected to an external power supply device.

5. The multi-purpose electrical charging structure of claim 4, wherein the insertion type connector has at least one configuration among micro 5pin, universal serial bus (USB) C-type, and lightning 8pin.

6. The multi-purpose electrical charging structure of claim 1, wherein the non-insertion type connector comprises:
a seating groove, which is concavely formed in the charging housing and into which and on which part of a housing having the non-insertion type portion of the electronic device formed therein is inserted and seated;
magnetism coupling members disposed on a bottom surface of the seating groove and allowing the magnetism coupling members of the non-insertion type port of the electronic device to be coupled to one another by magnetism; and
contact pins through which, when the magnetism coupling members are coupled to one another by magnetism, a contact terminal of the non-insertion type port of the electronic device is in a contact point with the contact pins in a non-insertion structure.

7. The multi-purpose electrical charging structure of claim 2, wherein the wireless charging pad comprises:
a seating pad, which is disposed in the charging housing and on which part of the housing having the wireless charging port of the electronic device formed therein is in surface contact with the seating pad;
a transmission coil, which is disposed inside the seating pad and forms a surface around which a coil relating to wireless charging is wound; and
a transmission coil substrate in which the transmission coil is disposed, which is connected to an interface unit so as to convert operating power into an induced electromotive force.

8. The multi-purpose electrical charging structure of claim 2, wherein the charging housing comprises:
a housing body; and
a power supply port extending from the housing body via a cable or protruding from the housing body and being connected to an external power supply device.

9. The multi-purpose electrical charging structure of claim 3, wherein the charging housing comprises:
a housing body; and
a power supply port extending from the housing body via a cable or protruding from the housing body and being connected to an external power supply device.

10. The multi-purpose electrical charging structure of claim 8, wherein the insertion type connector has at least one configuration among micro 5pin, universal serial bus (USB) C-type, and lightning 8pin.

11. The multi-purpose electrical charging structure of claim 9, wherein the insertion type connector has at least one configuration among micro 5pin, universal serial bus (USB) C-type, and lightning 8pin.

12. The multi-purpose electrical charging structure of claim 3, wherein the non-insertion type connector comprises:
a seating groove, which is concavely formed in the charging housing and into which and on which part of a housing having the non-insertion type portion of the electronic device formed therein is inserted and seated;
magnetism coupling members disposed on a bottom surface of the seating groove and allowing the magnetism coupling members of the non-insertion type port of the electronic device to be coupled to one another by magnetism; and
contact pins through which, when the magnetism coupling members are coupled to one another by magnetism, a contact terminal of the non-insertion type port of the electronic device is in a contact point with the contact pins in a non-insertion structure.

13. The multi-purpose electrical charging structure of claim 3, wherein the wireless charging pad comprises:
a seating pad, which is disposed in the charging housing and on which part of the housing having the wireless charging port of the electronic device formed therein is in surface contact with the seating pad;
a transmission coil, which is disposed inside the seating pad and forms a surface around which a coil relating to wireless charging is wound; and
a transmission coil substrate in which the transmission coil is disposed, which is connected to an interface unit so as to convert operating power into an induced electromotive force.
